(19) United States
(12) Patent Application Publication
(10) Pub. No.: US 2006/0035126 A1
(43) Pub. Date: Feb. 16, 2006

(54) Fuel cell system and method for operation of a fuel cell system

(75) Inventors: Michael Kurrle, Esslingen (DE); Matthias Lederbogen, Blaubeuren (DE); Gerald Post, Suessen (DE); Volker Schempp, Holzmaden (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/202,406

(22) Filed: Aug. 11, 2005

(30) Foreign Application Priority Data
Aug. 13, 2004 (DE) 10 2004 039 417.2

(51) Int. Cl. H01M 8/04

(52) U.S. Cl. 429/26; 429/34; 429/13

(57) ABSTRACT

A fuel cell system is provided having at least one switching means (16, 17, 18) for reversing the direction of a flow of at least one working medium in a fuel cell unit (10), with the fuel cell unit (10) having a cathode (11), an anode (12) and a cooling water device (13) in a housing (26). Advantageously more reliable operation with less component complexity is made possible by the switching means (16, 17, 18) being arranged outside the housing (26).

Priority is claimed to German Patent Application DE 10 2004 039 417.2, filed Aug. 13, 2004, the entire disclosure of which is hereby incorporated by reference herein.

### FIELD OF THE INVENTION

The invention relates to a fuel cell system and a method for operation of a fuel cell system.

### BACKGROUND

It is known for the direction of working media such as cooling water, a hydrogen-rich medium and an oxygen-rich medium which flow through a fuel cell unit to be reversed from time to time in fuel cell systems. The direction reversal allows more uniform loading of the fuel cell unit and more homogeneous operating conditions. Slides and the like which can be operated by means of linkages are normally provided for this purpose within the fuel cell unit.

### SUMMARY OF THE INVENTION

In accordance with the present invention, a fuel cell system and a method for its operation is provided, in which more reliable operation is possible with little mechanical complexity for reversing the direction of a flow of working media.

In accordance with an embodiment of the present invention, a fuel cell system is provided which includes a fuel cell unit having a cathode, and anode, and a cooling water device in a housing. The fuel cell system further includes one or more switches arranged to reverse the direction of a flow of at least one working medium in the fuel cell unit, wherein at least one of the switches is arranged outside the housing.

In accordance with another embodiment of the present invention, a method for operation of a fuel cell system is provided for a fuel cell system having at least one switch by means of which a flow direction of working media for a fuel cell unit is reversed, and wherein the fuel cell unit has a cathode, an anode and a cooling water device in a housing. In accordance with this embodiment, the method of operation comprises buffering a brief dip in the electrical voltage of the fuel cell unit which occurs when the direction of the flow of at least one working medium is reversed.

In accordance with another embodiment of the present invention, a fuel cell system includes a fuel cell unit having a cathode, and anode, and a cooling water device in a housing; at least one switch arranged to reverse the direction of a flow of at least one working medium in the fuel cell unit, wherein the switch is arranged outside the housing; and the fuel cell system operates to buffer a brief dip in the electrical voltage of the fuel cell unit which occurs when the direction of the flow of at least one working medium is reversed.

As described above, fuel cell systems according to embodiments of the present invention has at least one switch for reversing the direction of a flow of at least one working medium flowing through a fuel cell unit, with the fuel cell unit having a cathode, an anode and a cooling water device in a housing. The switch (i.e., switching means) is arranged outside the housing. A fuel cell unit is normally formed from two or more fuel cell stacks, whose media supply can be connected in parallel and/or in series. The arrangement according to the embodiment of the present invention simplifies the configuration of the fuel cell stacks, since there is no need for slides within the housing. Since the fuel cell stacks may have considerable lengths, a linkage is required in conventional fuel cell units for mechanical operation of the slide, and is susceptible to defects, with a corresponding axial length. This problem is avoided with the arrangement according to the present invention. Furthermore, in the event of a defect in the switching means, it is more easily accessible and can be repaired or replaced without having to destroy the fuel cell unit. The invention can be used for various types of fuel cell units. The component complexity for the switching means is reduced. A switching valve for the relevant working medium is preferably provided as the switch or switching means.

In one advantageous development of the invention, the switching means for reversing the direction of a flow of cooling water is arranged outside the housing. Alternatively or additionally, the switching means for reversing the direction of a flow of an oxidizing working medium can likewise be arranged outside the housing and/or the switching means for reversing the direction of a flow of a reducing working medium is arranged outside the housing. All of the switching means are preferably arranged outside the housing. One advantage is that this allows uniform moisturization of the fuel cell unit over its operating time, while at the same time reducing the component complexity for the switching means.

In the case of a method according to an embodiment of the present invention for operation of a fuel cell system having switching means, by means of which a flow of working media for a fuel cell unit is reversed, with the fuel cell unit having a cathode, an anode and a cooling water device in a housing, it is proposed that a brief dip in the electrical voltage of the fuel cell unit which occurs when the direction of the flow of working media is reversed is buffered. This therefore has virtually no adverse affect on the operation of the fuel cell system for a user, for example a driver of a fuel cell vehicle.

The dip is preferably buffered by an electrical storage means providing additional electrical power. In one exemplary application in a preferred fuel cell vehicle, it is thus possible to ensure that a traction drive which is supplied from the fuel cell system is not interrupted or is subject to a short-term power reduction, which may be found to be disturbing. A storage means such as this may be a capacitor, a battery with an appropriately high voltage and/or a so-called supercap.

The dip can be buffered by the flow direction being reversed in an operating phase with a decrease in power requirement to the fuel cell unit. If, for example, the driver in said fuel cell vehicle reduces the gas supply or even brakes the vehicle, the direction of the working medium or media can expediently be reversed in this phase. No drop in power in the fuel cell unit is perceived by the driver.

The dip can also be buffered by the power being limited in an operating phase with an increase in power requirement to the fuel cell unit. If the driver of said fuel cell vehicle releases more gas, the direction of the working medium or media can be reversed, and this is noticeable only in a briefly lower acceleration.

In one preferred development of the invention, the various methods for buffering the voltage dip of the fuel cell unit can also be used individually or may be combined with one another in total, or may be used as required.

A vehicle is preferred having a fuel cell system according to the invention which is operated according to the invention. The fuel cell system may be used for traction or else as an electrical supply for a component in a vehicle with a fuel cell drive or an internal combustion engine.

### BRIEF DESCRIPTION OF THE DRAWING

The invention will be explained in more detail in the following text with reference to an exemplary embodiment that is described in the drawing. The drawing, the description and the claims contain numerous features in combination, which a person skilled in the art will also expediently consider individually and combine them to form sensible further combinations.

FIG. 1 shows, schematically, one preferred refinement of a fuel cell system according to the invention, as may be used by way of example in a preferred fuel cell vehicle.

Details of the fuel cell system such as the gas supply, any gas generating system and the like are not illustrated, but will be familiar to those skilled in the art.

### DETAILED DESCRIPTION

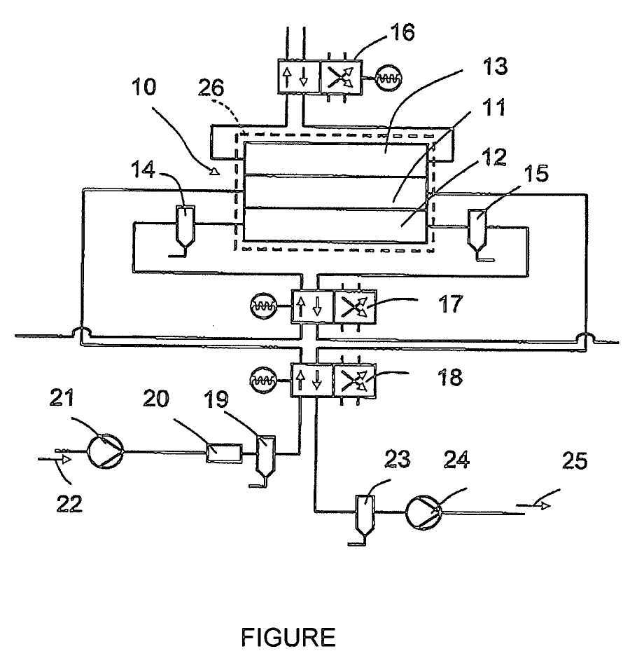

As can be seen from FIG. 1, a preferred fuel cell system has switches or switching means 16, 17, 18 in the form of switching valves for reversing the direction of a flow of working media which are supplied to a fuel cell unit 10 and are arranged outside a housing 26 of the fuel cell unit 10. The respective inputs and outputs for the working media for the fuel cell unit 10 are thus interchanged.

Anode spaces and cathode spaces of individual fuel cells which are arranged in fuel cell stacks and form the fuel cell unit 10, as well as their cooling water spaces are illustrated in a simplified form as a single cathode 11, anode 12 and cooling water device 13.

Cooling water is fed into the cooling water device 13 through its input via a switching means 16 that is arranged outside the housing 26, and is carried away again through its output and through the switching means 16. While the switching means 16 is reversed, the input and output are interchanged with respect to the flow of the working medium.

The switching means 17 for reversing the flow direction of an oxidizing working medium 22, in particular air, is arranged outside the housing 26. Air is sucked in from the surrounding area, is moisturized via a humidifier 20, and liquid water is separated in a condensation separator 19. The moisturized oxidant is passed through its input into the cathode 11, where it also carries product water of the fuel cell reaction, leaves the cathode 11 through its output, and carries this as cathode exhaust gas to a condensation separator 23, before the cathode exhaust gas is disposed of as exhaust air 25. A pump 24 is arranged downstream from the condensation separator 23 in the exhaust gas train. While the switching means 17 is reversed, the input and output are interchanged with respect to the flow of the working medium.

The working medium can be supplied from a tank (which is not illustrated) or from a gas generating system (which is not illustrated) to the switching means 18, which is arranged outside the housing 26, in order to reverse the flow direction of a reducing working medium, in particular hydrogen gas or a hydrogen-rich reformate. Any excess moisture content in the working medium can be separated in a condensation separator 14 before the reducing agent passes through its input into the anode 12. Anode exhaust gas is dehumidified on the output side in a condensation separator 15 and is disposed of, for example by being supplied to a burner or the like, which is not illustrated. When the switching means 18 is reversed, the input and output are interchanged with respect to the flow of the working medium.

According to the illustrated embodiment of the present invention, a brief dip in the electrical voltage of the fuel cell unit 10 which occurs on reversing the direction of the flow of the working media is buffered by an electrical storage means, which is not illustrated, providing additional electrical power and/or by switching to the fuel cell unit 10 in an operating phase when the power requirement is decreasing, and/or by limiting the power for switching in an operating phase with an increase in power requirement to the fuel cell unit 10. In the case of power limiting, by way of example, the maximum current with which the fuel cell unit 10 can be loaded can be limited, with this maximum current being of such a magnitude that a brief voltage dip while switching the flow direction is noticeable only in a somewhat longer acceleration phase, which is virtually imperceptible by a driver.

A suitable controller, which is not illustrated, is expediently used to check when switching of the flow direction is necessary, for example as a function of an operating period and/or power consumption or the like, and a next suitable switching time is then chosen when one of the operating phases described above occurs, or switching takes place immediately when a suitable storage means, which is not illustrated, is available, which has the capability to electrically cover a voltage dip from the fuel cell unit 10.

### List of Reference Symbols

10 Fuel cell
11 Cathode
12 Anode
13 Cooling water
14 Condensation separator
15 Condensation separator
16 Switching means
17 Switching means
18 Switching means
19 Condensation separator
20 Humidifier
21 Pump
22 Surrounding area
23 Condensation separator
24 Pump
25 Exhaust air
26 Housing

What is claimed is:

1. A fuel cell system, comprising:
a fuel cell unit having a cathode, and anode, and a cooling water device in a housing; and
one or more switches arranged to reverse the direction of a flow of at least one working medium in the fuel cell unit, wherein at least one of the switches is arranged outside the housing.

2. The fuel cell system as claimed in claim 1, wherein the one or more switches includes a first switch, the at least one working medium includes cooling water, and the first switch is arranged to reverse the direction of flow of the cooling water, and wherein the first switch is arranged outside the housing.

3. The fuel cell system as claimed in claim 1, wherein the one or more switches includes a second switch, the at least one working medium includes an oxidizing working medium, and the second switch is arranged to reverse the direction of flow of the oxidizing working medium, and wherein the second switch is arranged outside the housing.

4. The fuel cell system as claimed in claim 2, wherein the one or more switches further includes a second switch, the at least one working medium further includes an oxidizing working medium, and the second switch is arranged to reverse the direction of flow of the oxidizing working medium, and wherein the second switch is arranged outside the housing.

5. The fuel cell system as claimed in claim 4, wherein the one or more switches further includes a third switch, the at least one working medium further includes a reducing working medium, and the third switch is arranged to reverse the direction of flow of the reduced working medium, and wherein the third switch is arranged outside the housing.

6. The fuel cell system as claimed in claim 1, wherein the one or more switches includes a third switch, the at least one working medium includes a reducing working medium, and the third switch is arranged to reverse the direction of flow of the reduced working medium, and wherein the third switch is arranged outside the housing.

6. The fuel cell system as claimed in claim 1, wherein the one or more switches includes a plurality of switches, and wherein all of the plurality of switches are arranged outside the housing.

7. The fuel cell system as claimed in claim 1, wherein the one or more switches includes a plurality of switches, and wherein one or more of the plurality of switches are arranged outside the housing.

8. A method for operation of a fuel cell system, wherein the fuel cell system has at least one switch by means of which a flow direction of working media for a fuel cell unit is reversed, and wherein the fuel cell unit has a cathode, an anode and a cooling water device in a housing, and wherein the method comprises
buffering a brief dip in the electrical voltage of the fuel cell unit which occurs when the direction of the flow of at least one working medium is reversed.

9. The method as claimed in claim 8, wherein the step of buffering the dip includes providing additional electrical power from an electrical storage device.

10. The method as claimed in claim 8, wherein step of buffering further includes the dip being buffered by the flow direction being reversed in an operating phase with a decrease in power requirement to the fuel cell unit

11. The method as claimed in claim 9, wherein the step of buffering further includes the dip being buffered by the flow direction being reversed in an operating phase with a decrease in power requirement to the fuel cell unit

12. The method as claimed in claim 8, wherein the step of buffering further includes the dip being buffered by the power being limited in an operating phase with an increase in power requirement to the fuel cell unit.

13. The method as claimed in claim 9, wherein the step of buffering further includes the dip being buffered by the power being limited in an operating phase with an increase in power requirement to the fuel cell unit.

14. The method as claimed in claim 10, wherein the step of buffering further includes the dip being buffered by the power being limited in an operating phase with an increase in power requirement to the fuel cell unit.

15. The method as claimed in claim 11, wherein the step of buffering further includes the dip being buffered by the power being limited in an operating phase with an increase in power requirement to the fuel cell unit.

16. A fuel cell system, comprising:
a fuel cell unit having a cathode, and anode, and a cooling water device in a housing; and
at least one switch arranged to reverse the direction of a flow of at least one working medium in the fuel cell unit, wherein the switch is arranged outside the housing;
wherein the fuel cell system buffers a brief dip in the electrical voltage of the fuel cell unit which occurs when the direction of the flow of at least one working medium is reversed.
